(19) United States
(12) Patent Application Publication
(10) Pub. No.: US 2009/0194747 A1
(43) Pub. Date: Aug. 6, 2009

(54) METHOD FOR IMPROVING ENVIRONMENTAL STABILITY OF CATHODE MATERIALS FOR LITHIUM BATTERIES

(75) Inventors: Feng Zou, Mississauga (CA); Huan Huang, Mississauga (CA); Lunzhi Liao, Mississauga (CA); Quan Min Yang, Mississauga (CA)

Correspondence Address: VALE INCO INTELLECTUAL PROPERTY GROUP, PARK 80 WEST - PLAZA TWO, SADDLE BROOK, NJ, 07663, US

(73) Assignee: VALE INCO LIMITED, Toronto (CA)

(21) Appl. No.: 12/025,270

(22) Filed: Feb. 4, 2008

(51) Int. Cl. H01B 1/00; B05D 5/12

(52) U.S. Cl. 252/519.33; 252/500; 252/520.2; 252/521.5; 427/77

(57) ABSTRACT

A method for improving the environmental stability of cathode materials used in lithium-based batteries. Most currently used cathode active materials are acutely sensitive to environmental conditions, e.g. leading to moisture and CO₂ pickup, that cause problems for material handling especially during electrode preparation and to gassing during charge and discharge cycles. Binder materials used for making cathodes, such as PVDF and PTFE, are mixed with and/or coated on the cathode materials to improve the environmental sensitivity of the cathode materials.

### TECHNICAL FIELD

The present invention relates to lithium batteries in general and more particularly to a method for improving the environmental stability of cathode materials used in non-aqueous, secondary lithium batteries during material handling in electrode and cell fabrication processes and during their related preceding transportation and storage.

### BACKGROUND OF THE INVENTION

With the continuing remarkable development of electronic apparatus such as portable computers, cell phones, music players, cameras, power tools, personal digital assistants (PDA's), electric vehicles, etc., there has been a strong parallel demand for the enhancement of the performance of the batteries used to supply power for these devices. Lithium battery systems are becoming the battery system of choice because of their superior energy and power densities when compared to other rechargeable battery technologies.

Lithium metal oxides, such as lithium cobalt dioxide, lithium nickel dioxide, lithium manganese spinel, lithium iron phosphate, nickel, cobalt, and manganese based lithium mixed metal oxides are the major active cathode materials currently used in lithium cells.

However, most of these cathode materials tend to adsorb CO₂ and/or moisture when exposed to ambient atmospheres during initial material handling processes and during subsequent electrode and battery fabrication operations. These problems usually cause product quality variations and result in performance degradation of non-aqueous Li-ion or Li polymer batteries made from these materials. They also cause failures and defects in electrode and cell fabrication manufacturing which lead to lowered yields.

Compared to cobalt-based cathode materials and other lithium mixed metal oxides, nickel-based cathode materials are more sensitive to the environment and are more prone to moisture and CO₂ uptake. As a result, lithium carbonate and lithium hydroxide impurities have been reported forming on the surface of the particles. Lithium hydroxide normally causes a rapid increase in viscosity or even gelation during electrode slurry preparation that results in irregular cathode coating thickness and causes defects on the aluminum foil during electrode preparation. Both types of impurities may cause other problems such as severe gas evolution during battery charge and discharge cycles under certain conditions.

In order to overcome the above-mentioned problems, a number of approaches have been investigated. Inorganic coatings, such as TiO₂, Al₂O₃, AlPO₄ and Co₃(PO₄) and organic coatings, such as fumed silica, carboxymethyl cellulose, etc. have been suggested to protect the cathode materials from debilitating uptakes However, there are several major issues with these compounds and methods: (1) Complex processes are required to make coatings that add significant costs to the underlying material production process; (2) Inactive coatings on the active materials result in decreased capacity of the coated materials; and (3) Introduction of foreign species in the cathode material and batteries that may not be chemically compatible with the battery system causing other undesirable reactions that may negatively impact battery performance.

Accordingly, there is a need for a process to overcome the environmental sensitivity, including undesirable weight gain, of cathode materials without a significant addition in production cost; without a decrease in material performance; and without introducing contaminants whose impact on long term performance of the batteries is unknown.

### SUMMARY OF THE INVENTION

There is provided a simple process for improving the environmental stability of cathode materials used in Li-base batteries during material handling, transportation, storage, electrode fabrication and cell fabrication. In the present process, one or more binder materials are introduced to a cathode material by coating them on and/or mixing them with the cathode material to improve the environmental stability of the cathode material. Binder materials are selected from those used in subsequent downstream electrode preparation steps such as PVDF (polyvinylidene difluoride) and PTFE (polytetrafluoroethylene). As a result, no additional foreign materials or species are introduced into the battery system to allay concern for potential problems in short and long term of battery service. There is no significant capacity and performance loss. For further environmental stability improvement, one or more selected Lewis acids may be added in the coating or mixing process. In order to obtain a high quality coating that is uniformly distributed and bonded on the cathode material particles, the coating of binder materials may be made by heating the dry mixture of the binder and the cathode material and/or by pre-dissolving the binder in a solution, and then mixing it with cathode material, followed by drying at elevated temperature. The temperature of heating can be up to above the glass transition temperature but below the decomposition temperature of the binder. The amount of binder usage should not be more than the amount of the binder used in electrode.

### PREFERRED EMBODIMENTS OF THE INVENTION

As noted above, cathode materials, especially Ni-based cathode materials for secondary Li batteries, are very sensitive to the environment since they tend to pick up moisture and carbon dioxide quickly. The moisture causes Li ions to leach out and form lithium hydroxide (LiOH). Carbon dioxide from the air will then react with the lithium hydroxide to form lithium carbonate on the surface of the material. As a result, the weight of the material will increase with time. The moisture and carbon dioxide absorption measured by weight gain will cause the problems in batteries and their manufacturing process as described above. The present expeditious method for reducing the environmental sensitivity of lithium-based cathode materials is simple, more efficient and less problematic when compared to other methods using inorganic and other organic coatings.

The adjective “about” before a series of values will be interpreted as also applying to each value in the series unless otherwise indicated.

In the present method, the cathode materials, which are typically particles, are mixed with or coated by binder materials after the cathode materials are synthesized with the objective to have the binder materials entirely or at least partially coated on the surface of the cathode materials. Those binder materials are typically selected from the binders used for making the battery electrodes. The intimate mixing of the binder materials with the cathode materials causes the binder materials to coat the cathode materials. Other coating methods may be employed such as: (1) wet coating: introducing a cathode material into a solvent containing solution with pre-dissolved binder material and then drying out the solvent to obtain the coated product; and (2) spray coating: spraying dry or pre-dissolved binder material on the surface of cathode material particles.

Examples of binder materials include fluoropolymers such as polyvinylidene fluoride (PVDF),polytetrafluoroethylene (PTFE), polyvinylidene fluoride-hexafluoropropylene copolymers (PVDF-BFP), and the like. Binders also include polyethylene, polyolefins and derivatives thereof, PEO (polyethylene oxide), PAN (polyacrylonitrile), SBR (styrene-butadiene rubber), PEI (polyamide) and the like or a mixture of above polymers.

Since the selected binder materials are hydrophobic they prevent moisture adsorption when they are coated on the surface of the cathode material. Moreover, since the coating material is also the binder used in subsequent electrode preparation, there is no concern regarding impurities being introduced into the electrode manufacturing process that may cause degradation of battery performance during subsequent charge and discharge cycles.

The binder material can be directly mixed with the cathode material at temperatures ranging from about room temperature up to about just below the decomposition temperature of the binder material. Heating softens or melts the binder material to improve the uniformity of the coating. Also, heat helps the coated binder material to cure on the cathode material surface for a more permanent bond between the core substrate and the coated material. It is preferable to conduct the present process at a temperature close to the glass transition temperature of the binder material. As noted previously, moisture and CO₂ can be quickly adsorbed by the cathode material after the cathode material is produced. Therefore it is preferable to perform the coating operation immediately after the cathode material has been synthesized although the improvement can also be achieved by mixing the cathode material and binder materials anytime before electrode preparation.

Mixing duration depends on the temperature applied. In principle, lower temperature requires longer mixing time. The mixing duration may range from about a minute to about 10 hours. Mixing should be conducted under a dry air atmosphere (relative humidity below about 40%) and standard ambient pressure in a closed mixer. It is preferable to use CO₂ free air to reduce the possibility of CO₂ pickup during mixing.

The amount of the binder material used in the present method should not exceed the amount of binder material used for making the ultimate cathode electrode. Otherwise, the excess quantity may cause a charge/discharge capacity decrease in the batteries. More preferably, the amount of the binder introduced may range from about 0.1% weight percent up to the maximum amount of the binder present in the finished cathode electrode; typically up to about 10% weight percent. On the other hand, the binder material usage in electrode preparation may be partially reduced according to the amount of binder material used for improving the environmental sensitivity of cathode materials.

In order to further improve the environmental stability of the cathode material, various Lewis acid compounds may be added into the mixture of binder materials and cathode materials during mixing. Examples of Lewis acids that can be added include oxalic acid, maleic acid (including maleic anhydride), benzoic acid, carboxylic acids (e.g. formic acid, acetic acid), sulfonic acids, (e.g. p-toluenesulfonic acid), citric acid, lactic acid, phosphoric acid, ammonium fluoride, ammonium hydrogen fluoride, ammonium phosphate, ammonium hydrogen phosphate, lithium dihydrogen phosphate, aluminum hydroxide, aluminum oxide, zirconium oxide, ammonium hexafluoroaluminate etc. or mixtures of the above. The function of the Lewis acid is to neutralize the LiOH that already exists at the end of the material synthesis process or forms on the surface of the cathode materials due to the exposure of the material to ambient atmosphere after its synthesis. The amount of the acidic compounds added will be from about 0.02 molar percentage to 5 molar percentage (“mol %”) of the cathode materials depending on the amount of residual LiOH on the cathode material. Higher amounts of such additives introduced into the cathode materials may cause a significant decrease of charge and discharge capacity although they may further improve the environmental stability of the cathode material. The molecular weight of the added Lewis acids should be selected below 200 g per mole to avoid any significant reduction of battery capacity.

A number of experiments were run to demonstrate the efficacy of the present invention:

### EXAMPLE 1-1

100 g of LiNiO₂ cathode material was mixed with 1 g (or 1 weight %) PVDF at a temperature of 180° C. for one hour. The mixing was carried out with a laboratory rotary mixer that may be operated at elevated temperature to obtain more uniform distribution of PVDF coating on the surface of the cathode material.

The above coated material was tested for weight gain with the following procedures: 20 g of the material was spread into a plastic container and then put into a climate chamber for exposure in air. The temperature of the climate chamber was 25° C. and the relative humidity was controlled at 50%. After 24 hours and 48 hours exposure respectively, the weight of the material was measured and compared to that before exposure to determine the weight gain. The results are shown in Table 1. For comparison purposes, a non-treated 20 g sample (“Comparative Example 1”) is also listed.

The above coated material was tested for electrochemical performance in coin type cells. The cathode electrode for the test was made of coated LiNiO₂, carbon black as a conductive additive and PVDF as the binder with a weight ratio of 90:6:4. Lithium metal was used as the anode and 1M LiPF₆ in ethylene carbonate and dimethyl carbonate (1:1 vol %) was used as electrolyte. The capacity of the cathode material was obtained with charge and discharge cycling between 3.0V to 4.3V. The results are shown in Table 2.

### EXAMPLE 1-2

100 g of the same LiNiO₂ cathode material as for Example 1-1 was further mixed with 0.5 g (or 0.5%) of oxalic acid (H₂C₂O₄) and 1 g (or 1%) of PVDF at a temperature of 180° C. for one hour. The mixing was carried out in the rotary mixer to obtain more uniform distribution of the PVDF coating on the surface of the cathode material.

The above coated material was tested for weight gain with the same procedure as described in Example 1-1. The results are shown in Table 1.

The above coated material was tested for electrochemical performance in coin type cells with the same procedure as described in Example 1-1. The results are shown in Table 2.

### COMPARATIVE EXAMPLE 1

Weight gain and electrochemical performance tests were carried out by using the original LiNiO₂ cathode material as for Example 1-1. There was no surface treatment on this original material. Both weight gain and electrochemical performance tests were conducted with the same procedures as described in example 1-1 respectively. The results are shown in Tables 1 and 2.

TABLE 1
Weight gain results of LiNiO2 cathode materials with
and without coatings

| Original | | | Weight gain % | |
|---|---|---|---|---|
| material | | Coating | 24 h | 48 h |
| LiNiO2 | Comparative | | 0.99 | 1.53 |
| | Example 1 | | | |
| | Example 1-1 | 1% PVDF | 0.33 | 0.54 |
| | Example 1-2 | 0.5% H₂C₂O₄ + 1% PVDF | 0.15 | 0.30 |

TABLE 2
Discharge capacity of LiNiO2 cathode materials with and
without coatings

| | | | Discharge capacity | |
|---|---|---|---|---|
| Original | | | (mAh/g) | |
| material | | Coating | C/10 | C/5 |
| LiNiO2 | Comparative | | 223.5 | 208.6 |
| | Example 1 | | | |
| | Example 1-1 | 1% PVDF | 215.8 | 206.0 |
| | Example 1-2 | 0.5% H₂C₂O₄ + 1% PVDF | 208.7 | 196.4 |

From Table 1, it can be seen that the weight gain during the exposure test shows a dramatic decrease by the PVDF coating and a further decrease by combining the PVDF and oxalate acid (H₂C₂O₄) coatings. At the same time, the drop in capacity was insignificant after the coating, especially for the singular PVDF coating when compared to the original comparative Example 1 LiNiO₂ material as shown in Table 2.

### EXAMPLE 2-1

100 g of LiNi_{0.8}Co_{0.15}Al_{0.05}O₂ cathode material was mixed with 1 g of PVDF at a temperature of 180° C. for one hour. The mixing was carried out with the rotary mixer to obtain a more uniform distribution of the PVDF coating on the surface of the cathode material.

The above coated material was tested for weight gain with the following procedures: 20 g of the material was spread into a plastic container and then put into a climate-chamber for exposure to air. The temperature of the climate chamber was 25° C. and the relative humidity was controlled at 50%. After 24 hours and 48 hours exposure respectively, the weight of the material was measured and compared to that before exposure to determine the weight gain. The results are shown in Table 3. For comparison purposes, a non-treated 20 g sample (“Comparative Example 2”) is also listed.

The above coated material was tested for electrochemical performance in coin type cells. The cathode electrode for the test was made of the coated LiNi_{0.8}Co_{0.15}Al_{0.05}O₂ cathode material, carbon black as a conductive additive and PVDF as a binder with a weight ratio of 90:6:4. Lithium metal was used as the anode and 1M LiPF₆ in ethylene carbonate and dimethyl carbonate (1:1 vol %) was used as electrolyte. The capacity of the cathode material was obtained with charge and discharge cycling between 3.0V to 4.3V. The results are shown in Table 4.

### EXAMPLE 2-2

100 g of same LiNi_{0.8}Co_{0.15}Al_{0.05}O₂ cathode material as in Example 2-1 was mixed with 0.5 g (or 0.5%) of oxalic acid (H₂C₂O₄) and 1 g (or 1%) of PVDF at a temperature of 180° C. for one hour. The mixing was carried out in the rotary mixer to obtain a more uniform distribution of the PVDF coating on the surface of the cathode material.

The above coated material was tested for weight gain using the same procedures as described in Example 2-1. The results are shown in Table 3.

The above coated material was tested for electrochemical performance with a coin type cell using the same procedure as described in Example 2-1. The results are shown in Table 4.

### COMPARATIVE EXAMPLE 2

Weight gain and electrochemical performance tests were carried out by using the original LiNi_{0.8}Co_{0.15}Al_{0.05}O₂ cathode material as with Examples 2-1 and 2-2. There was no any further surface treatment on this original material. The results are shown in Tables 3 and 4.

TABLE 3
Weight gain results of LiNi_{0.8}Co_{0.15}Al_{0.05}O₂ cathode materials
with and without coatings

| Original | | | Weight gain % | |
|---|---|---|---|---|
| Material | Sample ID | Coating | 24 h | 48 h |
| LiNi_{0.8}Co_{0.15}Al_{0.05}O₂ | Comparative | | 0.46 | 0.65 |
| | Example 2 | | | |
| | Example 2-1 | 1% PVDF | 0.22 | 0.33 |
| | Example 2-1 | 0.5% | 0.16 | 0.25 |
| | | H₂C₂O₄ + | | |
| | | 1% PVDF | | |

TABLE 4
Weight gain results of LiNi_{0.8}Co_{0.15}Al_{0.05}O₂ cathode materials
with and without coatings

| | | | Discharge Capacity | |
|---|---|---|---|---|
| Original | | | (mAh/g) | |
| material | Sample ID | Coating | C/10 | C/5 |
| LiNi_{0.8}Co_{0.15}Al_{0.05}O₂ | Comparative | | 187.6 | 183.1 |
| | Example 2 | | | |
| | Example 2-1 | 1% PVDF | 187.5 | 182.9 |
| | Example 2-1 | 0.5% | 174.4 | 171.0 |
| | | H₂C₂O₄ + | | |
| | | 1% PVDF | | |

From Table 3, it can be seen that the weight gain during the exposure test shows a dramatic decrease by PVDF coating and a further decrease by a combined PVDF and oxalate acid (H₂C₂O₄) coating. At the same time, the drop in capacity was insignificant after the coating, especially for the singular PVDF coating compared to the original LiNiO₂ material as shown in Table 4.

While in accordance with the provisions of the statute, there is illustrated and described herein specific embodiments of the invention. Those skilled in the art will understand that changes may be made in the form of the invention covered by the claims and that certain features of the invention may sometimes be used to advantage without a corresponding use of the other features.

1-23. (canceled)

24. A method for improving the environmental stability of cathode material for lithium-based battery cathodes, the method comprising:
a) providing a lithium-based compound comprising LiNiO₂;
b) introducing a binder including PVDF to the lithium-based compound and mixing them wherein the binder ranges up to about 10% of the cathode and is used in the downstream preparation of the cathode disposed in the battery;
c) heating the lithium-based compound and the binder to about 180° C. for about an hour;
d) adding a Lewis acid to the lithium-based compound and the binder, the Lewis acid having a molecular weight of less than about 200 grams per molar compound; and
e) causing the binder to coat the lithium-based compound.

25. The method according to claim 24 including spray coating the lithium-based compound with the binder.

26. The method according to claim 24 wherein the lithium-based compound consists essentially of LiNi_{0.3} CO_{0.15} AI_{0.05} Q₂.

27. The method according to claim 24 wherein the Lewis acid is selected from at least one of the group consisting of oxalic acid, maleic acid, benzoic acid, carboxylic acid, sulfonic acid, citric acid, lactic acid, phosphoric acid, ammonium fluoride, ammonium hydrogen fluoride, ammonium phosphate, ammonium hydrogen phosphate, lithium dihydrogen phosphate, aluminum hydroxide, aluminum oxide, zirconium oxide, and ammonium hexafluoroaluminate.

28. The method according to claim 24 including wet coating by introducing the lithium-based compound into a solution of the pre-dissolved binder and a solvent, and then drying the solvent.
